(19) United States
(12) Patent Application Publication
(10) Pub. No.: US 2011/0177903 A1
(43) Pub. Date: Jul. 21, 2011

(54) Continuously Variable Planet Gear Transmission

(76) Inventor: Joshua Campbell, Winnipeg (CA)

(21) Appl. No.: 13/010,038

(22) Filed: Jan. 20, 2011

Related U.S. Application Data
(60) Provisional application No. 61/297,043, filed on Jan. 21, 2010.

(51) Int. Cl. F16H 9/26; F16H 55/52

(52) U.S. Cl. 475/149; 475/182; 474/8

(57) ABSTRACT

A transmission system for a vehicle with an electric motor includes a continuously variable transmission having a drive pulley, a driven pulley connected to one wheel of the vehicle, and a belt operatively connected between the drive pulley and the driven pulley such that a pitch radius of the belt in contact with each pulley is variable. The transmission system further includes a planetary gear set having a sun gear connected to the output of the motor, a ring gear connected to the drive pulley, and a planet gear operatively connected between the sun gear and the ring gear. The planet gear is rotatable about a respective planet gear axis which is fixed in position relative to the sun gear axis such that the planetary gear set is arranged to be operable at a fixed gear reduction.

This application claims the benefit under 35 USC 119(e) from U.S. Provisional application No. 61/297,043, filed Jan. 21, 2010.

### FIELD OF THE INVENTION

The present invention relates to a continuously variable planet gear transmission system comprising a belt type continuously variable transmission in connection between an electric motor and a respective driven wheel and an integral planetary gear set providing a fixed gear reduction from the electric motor to the continuously variable transmission, and more particularly, the present invention relates to a pair of continuously variable planet gear transmissions operable independently of one another between respective electric motors and respective laterally opposed drive wheels of a vehicle.

### BACKGROUND

With evolving demands for alternative energies, new approaches need to be taken in developing the efficient transmission of these energies.

To some extent, hybrid drive technologies are only as good as the systems transmitting the power; mechanically this transfer of energy is done with transmission systems such as Continuous Variable Transmissions (CVTs) or the conventional manual/automatic transmissions. These transmission systems have been developed for conventional combustion engines, and have been adapted for parallel drive hybrids systems. With the new development of series drive hybrid systems the use of previously existing transmissions can be quite inefficient due to motor characteristics and can incur parasitic losses such as rotating mass and weight. These inefficiencies are principally due to the fact that series drive hybrids behave quite differently from other power plants and require the development of the energy transmissions systems capable of doing the same. Conventional power plants do not operate at their peak efficiency with the transmission system shifting constantly to deliver adequate power. A series drive electric hybrid uses only the electric motors to drive the vehicle forward, and with the characteristics of the electric motor this shifting characteristic of some types of conventional transmissions creates losses due to rotating mass and variability in the operating point of the motor. Development of the series drive electric hybrid is creating a more versatile and efficient energy consumption market, these technologies can be used in a wide range of applications, and their development is a necessity to improve upon our energy conservation and sustainability. The diversified approach in seeking out more efficient energy solutions has created competitions like the international society of automotive engineering hybrid competition, where these new approaches have an accelerated development and are tested in the most extreme energy consumption environments, racing.

### SUMMARY OF THE INVENTION

According to one aspect of the invention there is provided a transmission system for at least one wheel of a vehicle, in combination with an electric motor comprising an output shaft, the transmission system comprising:

a continuously variable transmission comprising a drive pulley, a driven pulley connected to rotate with said at least one wheel, and a belt operatively connected between the drive pulley and the driven pulley such that a pitch radius of the belt in contact with each pulley is variable; and

a planetary gear set comprising a sun gear connected to rotate with the output shaft of the electric motor about a sun gear axis, a ring gear connected to rotate with the drive pulley of the continuously variable transmission, and at least one planet gear operatively connected between the sun gear and the ring gear;

said at least one planet gear being rotatable about a respective planet gear axis which is fixed in position relative to the sun gear axis such that the planetary gear set is arranged to be operable at a fixed gear reduction between the output shaft of the electric motor and the drive pulley of the continuously variable transmission.

Preferably the sun gear is directly connected in fixed relation with the output shaft of the electric motor so as to be arranged for concentric rotation with a rotor of the electric motor.

Preferably the drive pulley is directly connected with the ring gear so as to be arranged for concentric rotation with the ring gear.

Preferably the drive pulley comprises fixed portion defining a first working surface which is generally conical and a movable portion defining a second working surface which is generally conical. In this instance, the belt is preferably arranged to be received between the first and second working surfaces, and the movable portion of the drive pulley is preferably movable in an axial direction relative to the fixed portion of the drive pulley such that an axial distance between the first and second working surfaces is adjustable to vary the pitch radius of the belt in contact with the working surfaces of the drive pulley. The fixed portion of the drive pulley may then be in fixed connection to the ring gear for rotation therewith.

The driven pulley is preferably directly connected to an axle of said at least one wheel so as to be arranged for concentric rotation with the axle of said at least one wheel.

The driven pulley may comprise a fixed portion defining a first working surface which is generally conical and a movable portion defining a second working surface which is generally conical. Preferably the belt is arranged to be received between the first and second working surfaces, and the movable portion of the driven pulley is movable in an axial direction relative to the fixed portion of the driven pulley such that an axial distance between the first and second working surfaces is adjustable to vary the pitch radius of the belt in contact with the working surfaces of the driven pulley and the fixed portion of the driven pulley is in fixed connection to the axle of said at least one wheel for rotation therewith.

There may be provided a controller associated with the continuously variable transmission and arranged to controllably vary the pitch radius of the belt in contact with the pulleys of the continuously variable transmission.

When one wheel comprises a rear wheel and there is provided a rear wheel speed sensor arranged to measure a rear wheel rotation speed of said at least one wheel and a front wheel speed sensor arranged to measure a front wheel rotation speed of a corresponding front wheel of the vehicle, the controller is preferably arranged to controllably vary the pitch radius of the belt in contact with the pulleys responsive to the measured front wheel rotation speed and the measured rear wheel rotation speed.

The controller may be arranged to detect a wheel slip condition based upon the measured front wheel rotation speed and the measured rear wheel rotation speed and limit power output from the electric motor in response to detection of the wheel slip condition.

When there is provided a wheel speed sensor arranged to measure a wheel rotation speed of said at least one wheel and a motor speed sensor arranged to measure a motor rotation speed, the controller is preferably arranged to controllably vary the pitch radius of the belt in contact with the pulleys responsive to the measured wheel rotation speed and the measured motor rotation speed.

The controller may be arranged to detect a belt slip condition based upon the measured wheel rotation speed and the measured motor rotation speed and limit power output from the electric motor in response to detection of the belt slip condition.

When the vehicle is supported on a pair of laterally opposed wheels in combination with a pair of electric motors comprising respective output shafts associated with the pair of laterally opposed wheels respectively, preferably a continuously variable transmission and a planetary gear set is provided in connection between each electric motor and the respective one of the laterally opposed wheels.

A controller is preferably associated with each continuously variable transmission so as to be arranged to controllably vary the pitch radius of the belt in contact with each pulley of the continuously variable transmission independently of the other controller.

When the electric motor is arranged to operate in a generator mode when the vehicle is in a braking condition, and preferably the controller associated with the continuously variable transmission is arranged to controllably vary the pitch radius of the belt in contact with the pulleys of the continuously variable transmission as a speed of the vehicle decreases during the braking condition.

The controller may be arranged to controllably vary the pitch radius of the belt in contact with the pulleys so as to provide a linear deceleration force to the electric motor in the generator mode.

According to a second aspect of the present invention there is provided a transmission system for a vehicle supported for rolling movement on a plurality of wheels, in combination with a pair of electric motors comprising respective output shafts, the transmission system comprising:

a pair of continuously variable transmissions, each associated with a respective one of the electric motors and a respective one of the wheels, each continuously variable transmission comprising a drive pulley operatively connected to the output shaft of the respective electric motor, a driven pulley operatively connected to the respective wheel, and a belt operatively connected between the drive pulley and the driven pulley such that a pitch radius of the belt in contact with each pulley is variable; and

a controller associated with each continuously variable transmission and arranged to controllably vary the pitch radius of the belt in contact with the pulleys of the continuously variable transmission independently of the other controller.

When each of said respective ones of the wheels comprises a rear wheel and there is provided a rear wheel speed sensor arranged to measure a rear wheel rotation speed of each rear wheel and a front wheel speed sensor arranged to measure a front wheel rotation speed of each of a pair of corresponding front wheels of the vehicle, the controllers are preferably arranged to controllably vary the pitch radius of the belt in contact with the pulleys responsive to the measured front wheel rotation speed and the measured rear wheel rotation speed.

The controllers are preferably arranged to detect a wheel slip condition based upon the measured front wheel rotation speed and the measured rear wheel rotation speed and limit power output from the respective electric motor in response to detection of the wheel slip condition.

There may be provided a wheel speed sensor arranged to measure a wheel rotation speed of each of said respective ones of the wheels and a motor speed sensor arranged to measure a motor rotation speed of each motor. Preferably the controllers are arranged to controllably vary the pitch radius of the belts in contact with the respective pulleys responsive to the measured wheel rotation speed and the measured motor rotation speed.

The controllers are preferably arranged to detect a belt slip condition of the respective belt based upon the measured wheel rotation speed and the measured motor rotation speed and limit power output from the respective electric motor in response to detection of the belt slip condition.

When each electric motor is arranged to operate in a generator mode when the vehicle is in a braking condition, the controllers are preferably each arranged to controllably vary the pitch radius of the respective belt in contact with the respective pulleys as a speed of the vehicle decreases during the braking condition.

The controllers are preferably each arranged to controllably vary the pitch radius of the respective belt in contact with the respective pulleys so as to provide a linear deceleration force to the respective electric motor in the generator mode.

The idea of the continuous variable planet gear transmission (CVPGT) is a transmission system capable of a large range of gear ratios (12.5:1 to 3:1) allowing for the power plant to operate at peak efficiency while maintaining low weight and losses. The transmission system of the present invention provides an efficient independent rear wheel transmission system, from electric motors to the rear wheels. The CVPGT will be integrated into the drive train of the vehicle twice, independently to each rear wheel.

An efficient high performance drive train has been developed which uses a wide range in gear ratios to maintain low power consumption and high vehicle performance. The continuously variable transmission has an internal planet gear system that permits a larger range of gear ratios to be controlled by a microcontroller to dictate specific gear ratios providing a determined set of performance parameters. For high torque power demands the CVPGT will permit a high torque ratio reducing the required power from the electric motors. A direct drive system permits 100% of the electric motor power to transfer maximum torque to the wheels. With the CVPGT a hybrid vehicle has been designed which will reach maximum traction torque of approximately 350 Nm with only 35 Nm 60% of the electric motor capacity. At speed the CPVGT will also permit the electric motors to maintain a constant rpm at the most efficient operating point of the chosen motors. In the illustrated embodiment, the motors are preferably maintained at a constant 2000 RPM; however other motors in other embodiments may be operated at other constant RPMs. The design will be compact, light weight, and able to withstanding instantaneous torque and shock loading from the electric motors and the drive time environment. The CVPGT assists in meeting the increasing needs for powerful efficient energy systems, reducing consumption and increasing the diversity of energy consumption options.

One embodiment of the invention will now be described in conjunction with the accompanying drawings in which:

### BRIEF DESCRIPTION OF THE DRAWINGS

FIG. 1 is a rear perspective view of an exemplary vehicle supporting the transmission system thereon.

FIG. 2 is an enlarged perspective view of the transmission system on the vehicle on FIG. 1.

FIG. 3 is a front perspective view of the transmission system shown separated from the vehicle.

FIG. 4 is a rear perspective view of the transmission system in a first gear ratio of the two continuously variable transmissions.

FIG. 5 is a rear perspective view of the transmission system with both continuously variable transmissions in a second gear ratio.

FIG. 6 is a front perspective view of the transfer linkages in the first gear ratio.

FIG. 7 is a front perspective view of the transfer linkages in the second gear ratio of FIG. 5.

FIG. 8 is a perspective view of a portion of the frame mount on the outer side of one of the planetary gear sets.

FIG. 9 is a perspective view of an inner side of the planetary gear set and the corresponding moveable portion of the drive pulley with the fixed portion of the drive pulley shown removed.

FIG. 10 is a perspective view of a cross section of the planetary gear set along the axis of the sun gear.

FIG. 11 is a similar view of the planetary gear set as FIG. 10 with the sun gear shown partially rotated and the bearings of the ring gear shown removed.

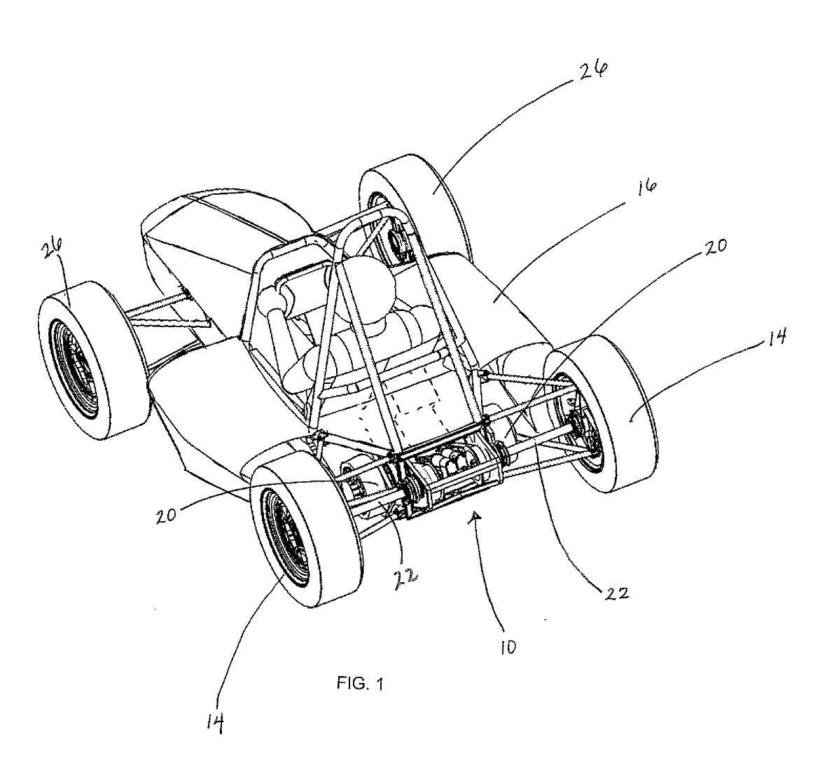

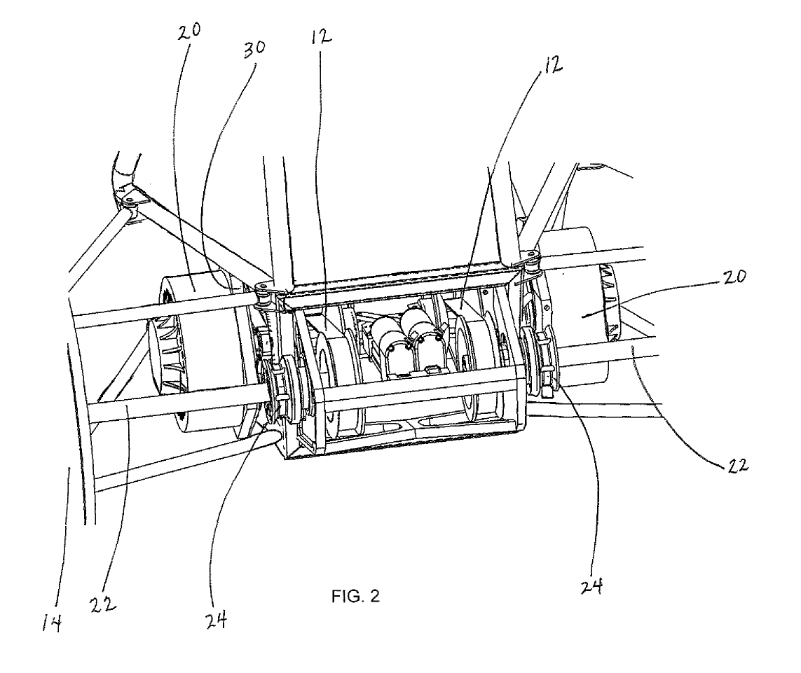

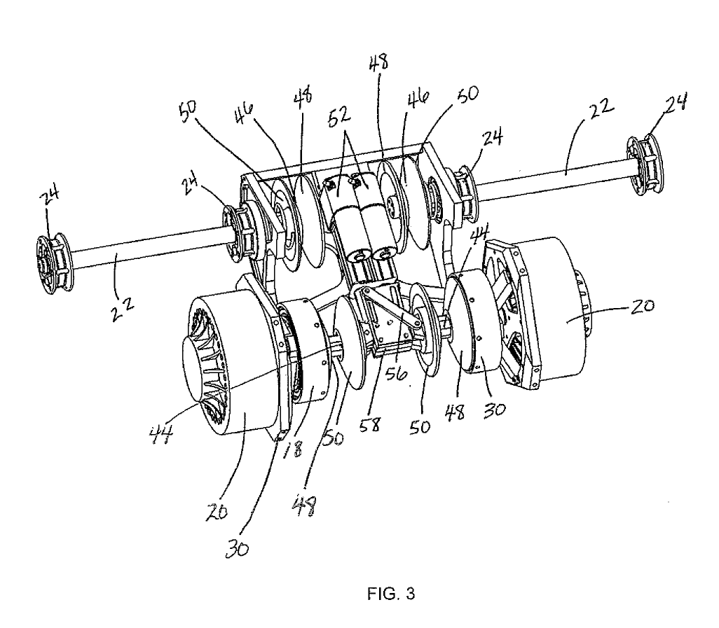

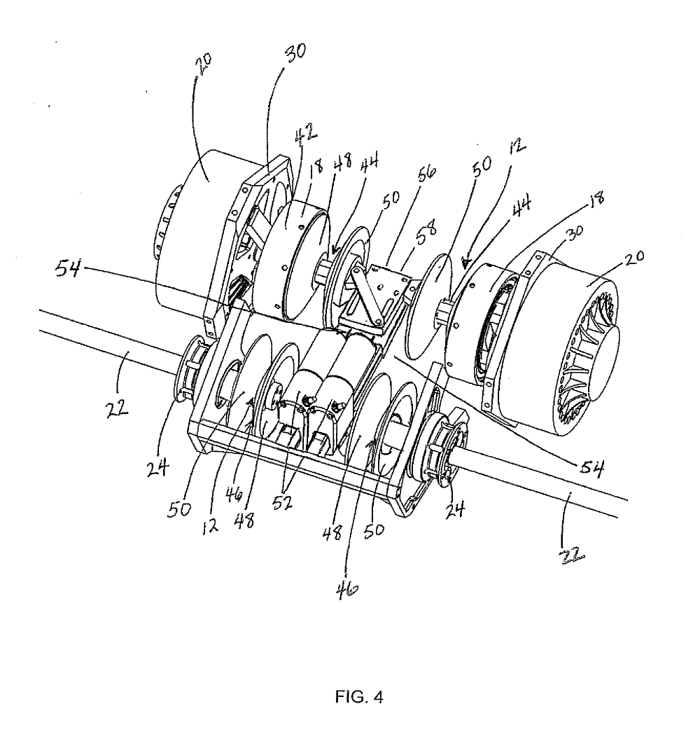

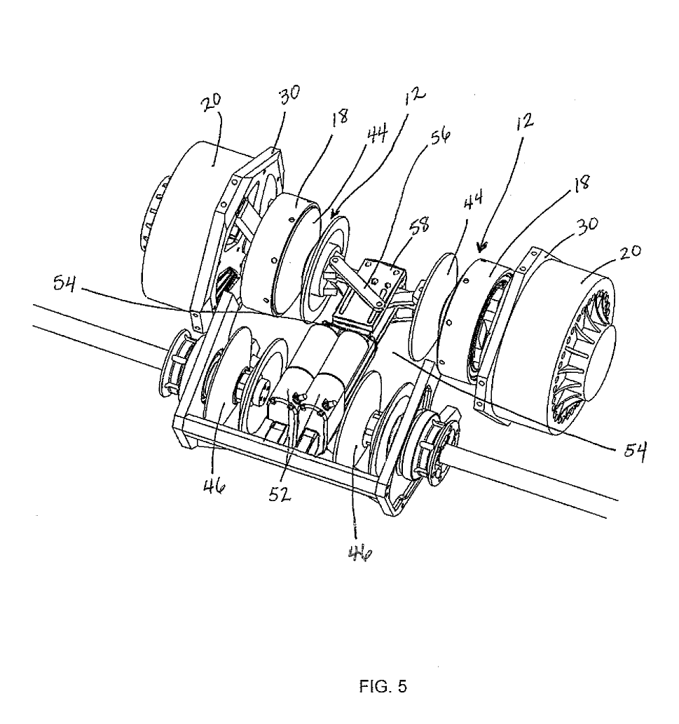

In the drawings like characters of reference indicate corresponding parts in the different figures.

### DETAILED DESCRIPTION

Referring to the accompanying Figures, there is illustrated a continuously variable planet gear transmission system generally indicated by reference numeral 10. The system 10 generally comprises a pair of continuously variable transmissions 12 associated with respective ones of a pair of laterally opposed drive wheels 14 of a vehicle 16.

In the illustrated embodiment, the two drive wheels 14 comprise laterally opposed rear wheels of the vehicle. Each continuously variable transmission (CVT) 12 incorporates an integral planetary gear set 18 so that the CVT together with the gear set 18 controls power transmission from a respective one of two electric motors 20 on the vehicle to respective ones of the two drive wheels 14.

The vehicle 16 further comprises a frame supported on the two rear drive wheels 14 by respective suspension assemblies such that each wheel includes a wheel axle 22 which is coupled between variable angle couplings 24 at opposed ends thereof in which the inner one of the couplings 24 is fixed in position on the frame while the outer one of the couplings is moveable together with the respective wheel with the suspension relative to the frame. The inner ends of the wheel axles with the couplings 24 thereon are coaxial with one another and laterally spaced apart at the rear end of the frame. The frame further comprises two corresponding front wheels 26 supported by respective suspension assemblies and which are steerable.

The two electric motors 20 are fixed onto the frame of the vehicle at laterally spaced apart positions. Each motor 20 includes a respective output shaft 28 which is coaxial with the rotor axis of the motor. The motors are mounted towards the outer sides of the frame such that the output shafts 28 of the two motors extend inwardly towards one another so as to be substantially coaxial, generally horizontal and perpendicular to the forward direction of the vehicle. The output shafts 28 of the motors are directly connected to the respective ones of the planetary gear sets 18 such that the gear sets are also coaxial with the rotor axis of the motors and with one another.

Each motor is supported on a respective frame mount 30 which is fixed in relation to the frame of the vehicle and which is supported between the motor and the respective gear set 18 to rotatably receive the output shaft 28 therethrough. The frame mounts 30 support the components of the respective gear sets 18 at the inner side thereof.

Each planetary gear set 18 includes a sun gear 32 fixed onto a central shaft which is keyed to rotate in fixed connection directly to the output shaft 28 of the respective motor. A suitable bearing 34 rotatably supports the central shaft of the sun gear extending through the frame mount 30 such that the sun gear is rotatable about a respective sun gear axis which is concentric and coaxial with the rotor of the respective electric motor.

The gear set 18 of each motor further comprises three planet gears 36 which are circumferentially spaced about the sun gear 32 in meshing engagement therewith. Each planet gear 36 is supported by respective bearings on the frame mount 30 for rotation about a respective planet gear axis which is fixed in position on the frame mount so as to be fixed in position relative to the central sun gear with which the planet gears are all geared to rotate.

A ring gear 38 surrounds the planet gears in concentric alignment with the sun gear such that the ring gear is rotatable about a respective ring axis which is coaxial with the sun gear axis and the rotor of the respective electric motor. A suitable bearing 40 supports the ring gear rotatably on the frame mount such that the ring gear meshes with all of the planet gears to rotate responsive to an input rotation to the sun gear.

A cylindrical housing 42 surrounds the ring gear and the planet gears about the sun gear so as to substantially surround and enclose the gears within a hollow interior of the cylindrical housing 42. The housing is fixed to the ring gear for rotation therewith about the central axis of the planetary gear set 18. The frame mount 30 is arranged to substantially enclose the outer side of the housing 42 between the respective electric motor and the planetary gear set 18.

Each CVT 12 comprises a drive pulley 44, a driven pulley 46, and a belt operatively connected between the drive pulley and the driven pulley so that the driven pulley is driven to rotate responsive to an input rotation to the drive pulley 44. The drive pulley is coaxial with the respective planetary gear set 18 and the respective electric motor. Alternatively the driven pulley 46 is coaxial with the inner end of the respective wheel axle so as to be rotatable about an axis which is parallel and spaced apart from the respective drive pulley.

Each of the pulleys comprises a fixed portion 48 which is fixed in the axial direction of rotation and which defines a first working surface which is generally conical in shape so as to taper radially inward in the axial direction towards an opposing movable portion 50. The movable portion 50 is part of each pulley also and is arranged to be axially slidable in relation to the respective fixed portion 48. Each movable portion defines a second working surface which is also conical in shape and which tapers radially inward in the axial direction towards the first working surface of the corresponding fixed portion 48.

Each drive pulley 44 supports the fixed portion 48 thereof in direct fixed connection to the cylindrical housing 42 and ring gear 38 of the respective gear set 18. The fixed portion 48 of the drive pulley fully spans and encloses the respective inner end of the cylindrical housing so that the gears of the gear set 18 are effectively enclosed between the fixed portion of the corresponding drive pulley at one end and the frame mount 30 at the axially opposing end.

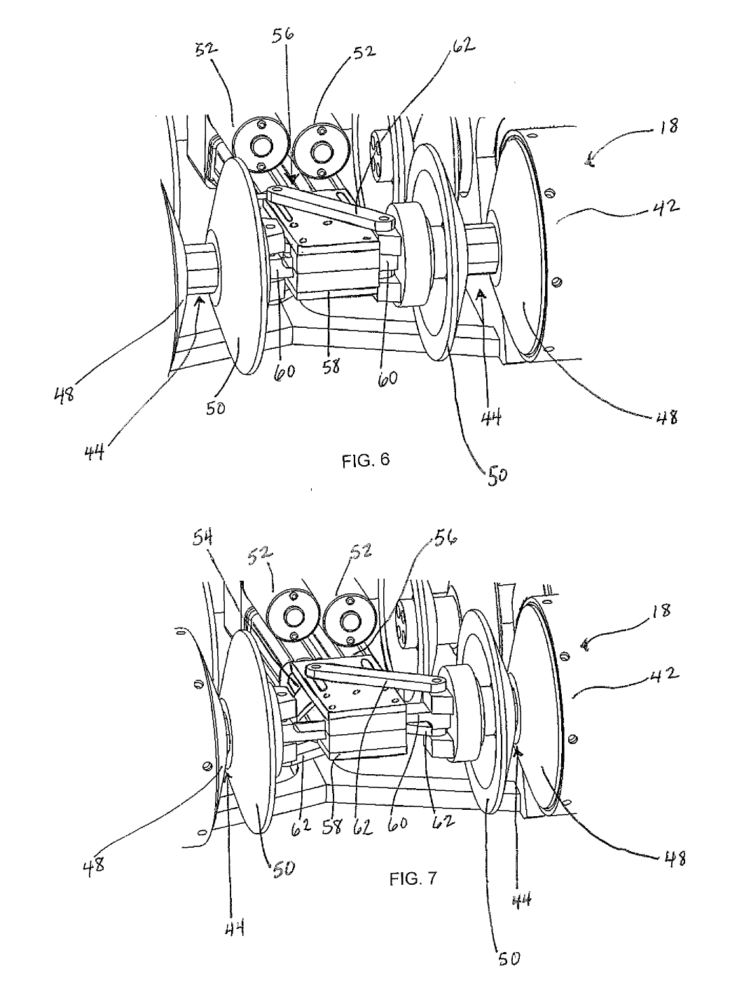

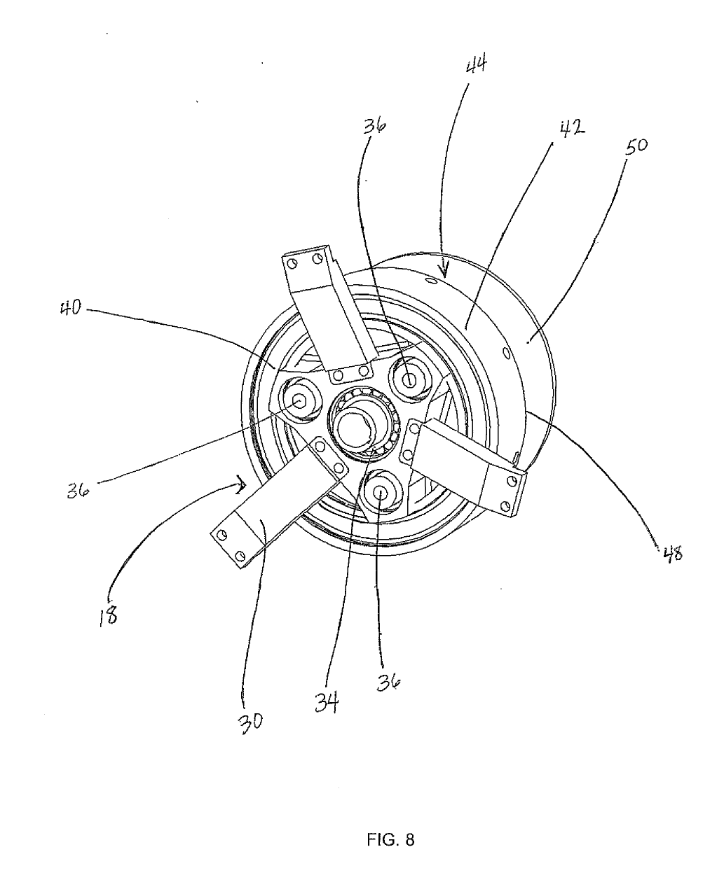

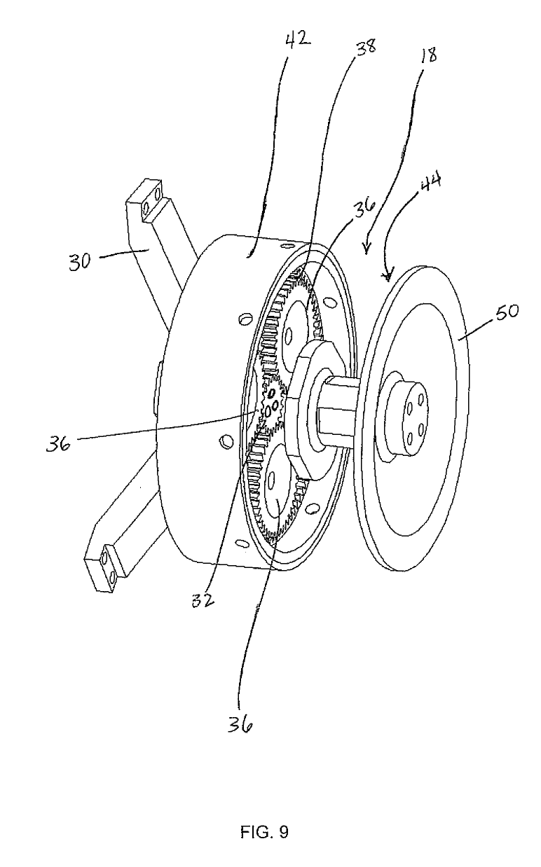

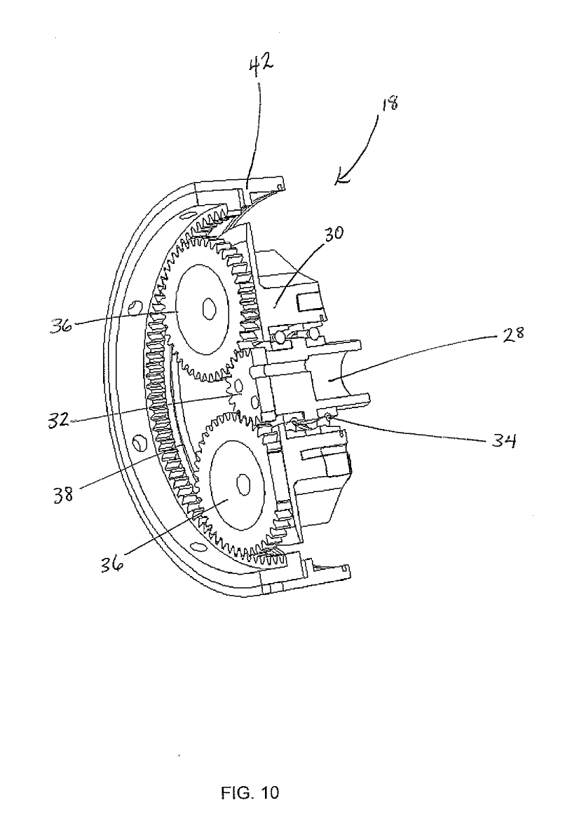

The movable portion of each drive pulley 44 is supported at an inner side in relation to the fixed portion at the outer side of the drive pulley. The movable portion is supported on a respective shaft of the pulley so as to be slidable therewith in the axial direction relative to the fixed portion slidably receiving the pulley shaft therein. Axial sliding movement of the movable portion of each drive pulley is shown between the two different gear ratio settings of FIGS. 6 and 7. The pulley shaft and the fixed portion of the drive pulley slidably receiving the pulley shaft therein have mating cross sections such that the two portions of the drive pulley are keyed for rotation together about the respective axis of the pulley.

The fixed portion 48 of each driven pulley 46 is integrally fixed at an inner end of a respective shaft of the pulley which is in direct and fixed coaxial connection to the coupling 24 at the inner end of the respective wheel axle 22 of the respective drive wheel. The movable portion 50 of each driven pulley is mounted at an outer side of the fixed portion for sliding movement along the pulley shaft. The movable portion and the pulley shaft again have mating cross sections so as to be keyed for rotation together while permitting the movable portion to be axially slidable relative to the fixed portion.

The belt is similar to conventional belts for CVT's in that the belt has a generally V shaped cross section so as to be suitably clamped between the first and second conical shaped working surfaces. As the axial distance between the first and second surfaces of each pulley is varied, the pitch radius of the belt riding within the space in contact between the two working surface varies so that the gear ratio of the CVT's are varied by controlling the axial position of the movable portions relative to the fixed portions.

A controller is associated with each drive pulley to control the axial position of the movable portion of the drive pulley. The axial positions of the movable portions of the corresponding driven pulleys are displaced responsive to the displacement of the drive pulleys to maintain an appropriate belt tension.

The controllers comprise respective linear actuators 52 providing micro position control for the two CVT's respectively. The actuators 52 are mounted parallel to one another between the driven pulleys such that a base of the actuator is fixed onto the frame and a sliding output member 54 of each actuator is oriented generally horizontally in the forward working direction of the vehicle so as to be substantially perpendicular to the axles and the axis of rotation of each of the pulleys.

A pair of transfer linkages are coupled between the rear ends of the sliding output members 54 and the respective movable portions 50 of the drive pulleys. The transfer linkages 56 are supported on a central frame mount 58 located between the drive pulleys. Each linkage 56 comprises a sliding link 60 which is slidable along the axis of the drive pulleys and which includes respective outer ends which are coupled by suitable bearings to the inner ends of the drive pulleys respectively.

Each linkage 56 further comprises a pivot link 62 having an inner end pivotally mounted to the respective sliding output member 54 and an outer end which is pivotally coupled to the sliding link 60 adjacent the outer end thereof. The pivot links 62 of the two linkages lie in overlapping planes of movement and are oriented transversely to one another such that each pivot link extends at an incline extending rearward and laterally outward from the inner ends to the outer ends thereof across the link 62 of the other linkage.

As each sliding output member 54 of the actuators is extended rearward, the corresponding sliding link 60 coupled thereto through the pivotal link 62 is displaced outwardly in the axial direction of the drive pulley to bring the movable portion and fixed portion of the respective drive pulley together which increases the pitch radius of the belt riding within the drive pulley. Retracting the sliding output member 54 of each actuator forwardly causes the reverse motion to displace the respective sliding links inwardly to separate the portions of the drive pulley and decrease the pitch radius of the belt in the drive pulley. The two actuators 52 are controlled by the respective controllers for independent movement relative to one another such that the gear ratios of the two CVT's 12 are independent of one another.

In this arrangement various performance characteristics can be controlled. For example when cornering, more power can be diverted to the outside wheels to push the vehicle out of a turn by diverting more power to the electric motor associated with the outside wheel and by appropriately adjusting the gear ratio of the corresponding CVT 12 thereof.

The controllers are further connected to various sensors and a computer control which function together to monitor various characteristics of the vehicle and adjust the gear ratios and motor outputs independently of one another.

In particular the transmission 10 operates in cooperation with a rear wheel speed sensor on each rear wheel which measures the rear wheel rotation speed, a front wheel speed sensor associated with each front wheel to measure the front wheel rotation speed, a motor speed sensor which measures a motor rotation speed of each of the two electric motors, and any other beneficial sensors which measure rotation speeds of the axles or various conditions of the CVT for example.

Using the sensors, the computer control is arranged to determine a wheel slip condition based upon front and rear wheel rotation speeds. In this instance the controller can limit power output from the motor through the CVT if wheel slip is detected.

The computer control is also arranged to determine belt slip based on motor and wheel rotation speeds so that the controller can limit power output from the motor through the CVT if belt slip is detected.

The arrangement of the CVT's 12 which are associated with the respective ones of the drive wheels for independent operation relative to one another also improves the performance of regenerative braking. In this instance, the electric motors are arranged to operate in a generator mode in which the rotation of the rotors of the electric motors are arranged to generate electric power while the vehicle speed is reduced in a braking condition. In the generator mode, the controller monitors the speed decrease of the vehicle and varies the pitch radius of the belt in contact with the respective pulleys to vary the gear ratio of the CVT's in order to recapture power from the deceleration forces in an optimal manner. Specifically the controllers may vary the gear ratios of the CVT's to provide a linear deceleration force to the electric motors in the generator mode to capture energy at the most efficient range of the motor throughout the deceleration.

As described herein, the design concept in itself comprises of three key sections, where each one requires the other to function properly. These sections are the Planet gear system, the Variable Radius Drive, and the Unit Housing encasing the systems.

The objective breakdown structure for the design of the Planet gear set requires the following:

The definition of the sun, planet, and ring gear dimensional properties and gear tooth designs, to obtain an initial gear reduction of 5:1 the sun gear will be ⅕ the diameter of the ring gear.

The selection of gear tooth type and gear design will permit the maximum transfer of torque throughout the system will maintaining a factor of safety of 1.5 in the sun gear and a factor of safety in the ring gear.

Force definitions and finite element analysis used the input of hand calculations to determine the reaction stress and strain throughout the gears allowing for the appropriate selection of material yield strength and hardness. 4340 carbon steel was chosen due to the high tensile strength of 710 mPa and other specific characteristics. Manufacturing process for gears will be done with wire EDM due to required tolerances and material considerations for the martensitic layer generated by the heat creating a preferable high hardness for the gear shell increasing the durability of the parts.

The Design of the Variable Radius Drive system requires a similar objective breakdown:

Pulley design and dimensional properties will permit for a further torque ratio multiplication of 2.5:1 making the final torque ratio of the transmission 12.5:1. The material chosen was 6061-T6 aluminum for the light weight and high hardness properties relative to machinability. The pulleys are designed to have a pressure angle of 20 degrees maintaining a small overall dimensional width of the system, while preferably decreasing the necessary clamping force on the belt.

With the pressure angle of the pulley specified at 20 degrees the rigidity of the belt needs to be high while maintaining linear flexibility for the tight radius bends. The belt will be ¼″ thick and ¾″ to 1″ wide, the center to center distance of the primary and secondary pulleys is approximately 8¾″ dictating a length of approximately 28″ for the belt.

The clamping force on the belt is the keystone of the CVT directly affecting the efficiency of the drive train. If the clamping force is too high the belt will wear and there will be substantial losses in heat, to light and the belt will slip reducing the amount of torque transferred through the system. With the clamping force in mind careful consideration must be paid to the determination of spring rates that dictate this clamping force. Multiple springs rates will be made and tested with an initial maximum clamping force approximated at 430 N.

Finally the optimization and considerations of how these two very different systems will be integrated into each other. Each system will exert forces in forms of heat, torques, and pressures and without the appropriate considerations the failures for the system will more than likely be catastrophic. The objective breakdown is as follows:

Dynamic analysis of integrated unit while insuring that the imposed forces of once system on the other will not cause undesirable heat or contact interference. Bearing selection is also important to insure that the system remains concentric under heavy loads. The isolation of the system from external vibrations, heat, and contamination calls for proper mounting and seals for the system.

With the correct execution of the above objectives the functional goals of the CVPGT according to a preferred embodiment of the invention will be as follows:
Gear ratios from 12.5:1 to 3:1
Maximum torques through the system of 60 Nm to 600 Nm (1:10 ratio) though at this torque lifespan of the transmission may be reduced
Factor of safety of 2 throughout the system
Gear ratio defined with linear actuation dictated by Microcontroller
Independent rear wheel power distribution eliminating need for differential system
Final weight of each CVT 12 of under 20 kgs

The design of the CVPGT is suited for use with a hybrid vehicle of the type shown in the illustrated embodiment. The drive train of the vehicle utilizes two independent CVPGTs each independently delivering power from an electric motor.

In each CVPGT, the driver pulley determines the final gear ratio while the driven pulley reacts to the change in pulley diameter to maintain belt tension. Internally the driver pulley contains a planetary gear providing an initial torque multiplication of 5:1. After the torque is transferred to the belt, the diameter of the driven and driver pulleys can further manipulate the ratio by 2.5:1 making the overall gear ratio range of the unit up to 12.5:1. The reasoning behind this is that it allows the electric motors to operate at peak torque or efficiency throughout a wide range of speeds. The CVPGT is a center piece of a programmable independent rear wheel drive train. The CVPGT has the potential to be manipulated for many uses to improve upon the packaging and reduce power consumption for many systems.

As described herein the present invention provides the following features: Planetary gear unit providing an initial fixed gear reduction (5:1); Integrated CVT unit with planetary gear unit provides final dynamic gear ratio (12.5:1); Final gear ratio is manipulated by the use of a linkage and actuator system controlled by 2 micro controllers; Gear ratio is determined by independently monitoring front and rear wheel speeds along with the motor speeds; This independent control is capable of monitoring wheel slip and reacting by limiting motor power to that wheel and also the control system monitors rear wheel speed and electric motor shaft speed to monitor belt slip; With the independent ratio control and the elimination of the differential the vehicles performance and handling potential is increased, thus the vehicle is capable of delivering dynamic power to the rear wheels and more power to the outside wheel pushing the vehicle out of a turn; Any CVT allows for an engine to run at an optimal position, however this CVPGT allows for small packaging and optimal performance of an electric motor; The CVPGT has significant size reduction and can reduce the average load on the motor during daily driving due to the large gear ratio; and Progressive Regenerative Braking again is a capability of the system by modifying the gear ratio of the electric motors to either maintain linear braking characteristics with increased regen or aggressively capture regen energy with aggressive ratio changes.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A transmission system for at least one wheel of a vehicle, in combination with an electric motor comprising an output shaft, the transmission system comprising:
a continuously variable transmission comprising a drive pulley, a driven pulley connected to rotate with said at least one wheel, and a belt operatively connected between the drive pulley and the driven pulley such that a pitch radius of the belt in contact with each pulley is variable; and
a planetary gear set comprising a sun gear connected to rotate with the output shaft of the electric motor about a sun gear axis, a ring gear connected to rotate with the drive pulley of the continuously variable transmission, and at least one planet gear operatively connected between the sun gear and the ring gear;
said at least one planet gear being rotatable about a respective planet gear axis which is fixed in position relative to the sun gear axis such that the planetary gear set is arranged to be operable at a fixed gear reduction between the output shaft of the electric motor and the drive pulley of the continuously variable transmission.

2. The system according to claim 1 wherein the sun gear is directly connected in fixed relation with the output shaft of the electric motor so as to be arranged for concentric rotation with a rotor of the electric motor.

3. The system according to claim 1 wherein the drive pulley is directly connected with the ring gear so as to be arranged for concentric rotation with the ring gear.

4. The system according to claim 3 wherein the drive pulley comprises fixed portion defining a first working surface which is generally conical and a movable portion defining a second working surface which is generally conical, the belt being arranged to be received between the first and second working surfaces, and the movable portion of the drive pulley being movable in an axial direction relative to the fixed portion of the drive pulley such that an axial distance between the first and second working surfaces is adjustable to vary the pitch radius of the belt in contact with the working surfaces of the drive pulley, and wherein the fixed portion of the drive pulley is in fixed connection to the ring gear for rotation therewith.

5. The system according to claim 1 wherein the driven pulley is directly connected to an axle of said at least one wheel so as to be arranged for concentric rotation with the axle of said at least one wheel.

6. The system according to claim 5 wherein the driven pulley comprises a fixed portion defining a first working surface which is generally conical and a movable portion defining a second working surface which is generally conical, the belt being arranged to be received between the first and second working surfaces, and the movable portion of the driven pulley being movable in an axial direction relative to the fixed portion of the driven pulley such that an axial distance between the first and second working surfaces is adjustable to vary the pitch radius of the belt in contact with the working surfaces of the driven pulley, and wherein the fixed portion of the driven pulley is in fixed connection to the axle of said at least one wheel for rotation therewith.

7. The system according to claim 1 wherein there is provided a controller associated with the continuously variable transmission and arranged to controllably vary the pitch radius of the belt in contact with the pulleys of the continuously variable transmission.

8. The system according to claim 7 wherein said at least one wheel comprises a rear wheel and wherein there is provided a rear wheel speed sensor arranged to measure a rear wheel rotation speed of said at least one wheel and a front wheel speed sensor arranged to measure a front wheel rotation speed of a corresponding front wheel of the vehicle, the controller being arranged to controllably vary the pitch radius of the belt in contact with the pulleys responsive to the measured front wheel rotation speed and the measured rear wheel rotation speed.

9. The system according to claim 8 wherein the controller is arranged to detect a wheel slip condition based upon the measured front wheel rotation speed and the measured rear wheel rotation speed and limit power output from the electric motor in response to detection of the wheel slip condition.

10. The system according to claim 7 wherein there is provided a wheel speed sensor arranged to measure a wheel rotation speed of said at least one wheel and a motor speed sensor arranged to measure a motor rotation speed, the controller being arranged to controllably vary the pitch radius of the belt in contact with the pulleys responsive to the measured wheel rotation speed and the measured motor rotation speed.

11. The system according to claim 10 wherein the controller is arranged to detect a belt slip condition based upon the measured wheel rotation speed and the measured motor rotation speed and limit power output from the electric motor in response to detection of the belt slip condition.

12. The system according to claim 1 for a vehicle supported on a pair of laterally opposed wheels, in combination with a pair of electric motors comprising respective output shafts associated with the pair of laterally opposed wheels respectively, wherein there is provided a continuously variable transmission and a planetary gear set in connection between each electric motor and the respective one of the laterally opposed wheels.

13. The system according to claim 12 wherein there is provided a controller associated with each continuously variable transmission and arranged to controllably vary the pitch radius of the belt in contact with each pulley of the continuously variable transmission independently of the other controller.

14. The system according to claim 1 wherein the electric motor is arranged to operate in a generator mode when the vehicle is in a braking condition, and wherein there is provided a controller associated with the continuously variable transmission and arranged to controllably vary the pitch radius of the belt in contact with the pulleys of the continuously variable transmission as a speed of the vehicle decreases during the braking condition.

15. The system according to claim 14 wherein the controller is arranged to controllably vary the pitch radius of the belt in contact with the pulleys so as to provide a linear deceleration force to the electric motor in the generator mode.

16. A transmission system for a vehicle supported for rolling movement on a plurality of wheels, in combination with a pair of electric motors comprising respective output shafts, the transmission system comprising:
a pair of continuously variable transmissions, each associated with a respective one of the electric motors and a respective one of the wheels, each continuously variable transmission comprising a drive pulley operatively connected to the output shaft of the respective electric motor, a driven pulley operatively connected to the respective wheel, and a belt operatively connected between the drive pulley and the driven pulley such that a pitch radius of the belt in contact with each pulley is variable; and
a controller associated with each continuously variable transmission and arranged to controllably vary the pitch radius of the belt in contact with the pulleys of the continuously variable transmission independently of the other controller.

17. The system according to claim 16 wherein each of said respective ones of the wheels comprises a rear wheel and wherein there is provided a rear wheel speed sensor arranged to measure a rear wheel rotation speed of each rear wheel and a front wheel speed sensor arranged to measure a front wheel rotation speed of each of a pair of corresponding front wheels of the vehicle, the controllers being arranged to controllably vary the pitch radius of the belt in contact with the pulleys responsive to the measured front wheel rotation speed and the measured rear wheel rotation speed.

18. The system according to claim 17 wherein the controllers are arranged to detect a wheel slip condition based upon the measured front wheel rotation speed and the measured rear wheel rotation speed and limit power output from the respective electric motor in response to detection of the wheel slip condition.

19. The system according to claim 16 wherein there is provided a wheel speed sensor arranged to measure a wheel rotation speed of each of said respective ones of the wheels and a motor speed sensor arranged to measure a motor rotation speed of each motor, the controllers being arranged to controllably vary the pitch radius of the belts in contact with the respective pulleys responsive to the measured wheel rotation speed and the measured motor rotation speed.

20. The system according to claim 19 wherein the controllers are arranged to detect a belt slip condition of the respective belt based upon the measured wheel rotation speed and the measured motor rotation speed and limit power output from the respective electric motor in response to detection of the belt slip condition.

21. The system according to claim 16 wherein each electric motor is arranged to operate in a generator mode when the vehicle is in a braking condition, and wherein the controllers are each arranged to controllably vary the pitch radius of the respective belt in contact with the respective pulleys as a speed of the vehicle decreases during the braking condition.

22. The system according to claim 21 wherein the controllers are each arranged to controllably vary the pitch radius of the respective belt in contact with the respective pulleys so as to provide a linear deceleration force to the respective electric motor in the generator mode.
